(19) United States
(12) Patent Application Publication
(10) Pub. No.: US 2014/0172524 A1
(43) Pub. Date: Jun. 19, 2014

(54) ANALYSIS AND PREDICTION OF COUPON EFFECTIVENESS

(71) Applicant: MICROSOFT CORPORTION, Redmond, WA (US)

(72) Inventor: Jose Saura, Kent, WA (US)

(73) Assignee: MICROSOFT CORPORATION, Redmond, WA (US)

(21) Appl. No.: 13/716,170

(22) Filed: Dec. 16, 2012

(51) Int. Cl. G06Q 30/02

(52) U.S. Cl. CPC G06Q 30/0211
USPC 705/14.13

(57) ABSTRACT

Coupons may be analyzed in order to determine the relationship between a coupon's content and the coupon's performance. In one example, a service delivers coupons to users, and receives feedback on the coupons' performance. For example, the service may receive information on how often users print a given coupon, or how often a coupon results in a conversion. The service may build a model of how a coupon's features, and external events such as the weather, correlate with a coupon's performance. The service may offer a portal that businesses use to design and disseminate coupons. The portal may suggest particular types of coupons, or particular coupon dissemination strategies, based on the models that have been built from analysis of prior coupons.

### BACKGROUND

Coupons are often distributed through electronic media. Consumers often receive coupons by e-mail, or may be presented with coupons while browsing web sites. A purpose of a coupon is to induce the user to engage in some desired behavior—e.g., visiting a store and/or making a purchase. However, issuing a coupon carries a cost: when a coupon is redeemed, in effect a business has to provide a service for less money that it would have collected for the same service without the coupon. Issuing a coupon justifies its cost if it is effective at inducing a consumer to engage in the sought-after behavior.

Many businesses that distribute coupons through electronic media, or that would like to distribute coupons, lack the information that would allow them to create effective coupons.

### SUMMARY

Coupons that have been issued may be analyzed to determine what makes them effective. The results of the analysis may be made available to businesses in the form of a tool that assists the businesses in designing coupons and coupon-distribution strategies.

In one example, a service controls, or has access to, several electronic distribution channels, such as personal computers, phones, game boxes, etc. The service may have the ability to present coupons in these various channels—e.g., showing a game player a coupon during a game intermission, or showing a phone user a coupon on the smart phone screen while the phone use is interacting with a shopping application. The service may maintain a coupon delivery platform. Businesses may submit their coupons to the delivery platform, and may have these coupons delivered to users through the various channels.

The delivery platform may receive information about how the users are reacting to the coupons. For example, if a user hovers over a coupon with a pointing device, or clicks a coupon, or saves and/or prints the coupon, the fact that these actions have occurred may be reported back to the coupon delivery platform. Additionally, businesses may report back to the delivery platform on the conversion rates associated with the coupons they have issued. The delivery platform may collect data on these facts, and the data may be provided to an analysis tool. The analysis tool may use the data to determine the relationship between the features of a coupon and its effectiveness. For example, the analysis tool may determine that coupons with particular colors, typefaces, or substantive offers are particularly effective at marketing certain kinds of products. Additionally, the analysis tool may determine how the effectiveness of particular types of coupons correlates with external factors, such as the time of year or the weather.

The results of the analysis tool may be used to advise businesses on how to create and distribute coupons. The service that provides the coupon delivery platform may have a portal through which businesses design and submit their coupons for dissemination. The portal may suggest coupon designs, or strategies for disseminating the coupons (e.g., the timing of the dissemination) in order to help the business optimize its use of the coupons.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which coupons are distributed, and in which information on the coupons is collected.

FIG. 2 is a block diagram of an example system that analyzes coupon information.

FIG. 3 is a block diagram of an example of a coupon assistance portal.

FIG. 4 is a flow diagram of an example process in which coupons are analyzed, and in which the analysis is used to assist in the authoring and dissemination of new coupons.

FIG. 5 is a block diagram of example components that may be used in connection with implementations of the subject matter described herein.

### DETAILED DESCRIPTION

As e-commerce expands, the use of electronic media to distribute coupons has increased. Online vendors often use their own sites to distribute coupons for the goods and services that they sell. Additionally, third-party services like Groupon have been used to distribute coupons.

A coupon is effective if it induces consumers to engage in some sought-after behavior—e.g., more purchases. However, issuing a coupon carries a cost to the issuer, in the sense that the value of the transaction is lower. Thus, businesses may want to maximize the effectiveness of their coupons. One way to issue an effective coupon is use information about the success of existing coupons when deciding how to design and issue a new coupon. However, many businesses do not have access to this type of information about existing coupons.

The subject matter described herein is a way to leverage information about existing coupons to help businesses design and promulgate new coupons online. The subject matter herein uses the vantage point of a delivery platform to marshal information about which coupons strategies work and which ones do not, in order to help businesses issue coupons that are more effective.

An information provider may distribute coupons through various channels. For example, an entity may have the ability to disseminate coupons on personal computers, smart phones, game platforms, tablet computers, etc. For example, a company that provides a game platform may be able to show a game player a coupon during an intermission in the game. As another example, a company that provides a smart phone platform may be able to show a coupon to the phone's user. It may be the same company that provides both the gaming platform and the smart phone platform, thereby allowing the company to issue coupons through both channels. When a user interacts with the coupon (e.g., by clicking the coupon to express interest), the provider of these platforms may receive information about the interaction. In this way, the provider is able to collect data concerning how much interest certain coupons are generating. The platform provider can analyze the success of the coupons to determine which types of coupons are successful, and which types are not. For example, the platform provider can use the data it receives to correlate the success of particular coupons with their visual appearance and the substance of the offer made. Additionally, the platform provider can correlate the success of a coupon with various other factors—e.g., the time of year (e.g., coupons for surplus pumpkins might be particularly successful in the days after Halloween), proximity to particular types of events (e.g., coupons for flashlights and tarps might be particularly successful right before a storm), etc.

When the platform provider builds a model of what types of coupons are likely to succeed, it can use this information to help businesses design coupons, and also to decide on a coupon dissemination strategy. For example, the platform provider might provide a coupon web portal, which business could use to design their coupons. Using the portal, the platform provider might suggest specific types of content and substantive offers that are likely to lead to an effective coupon campaign. For example, the portal might tell businesses that one color of coupon is more effective at selling a certain type of product than another (e.g., green coupons might be more effective than brown coupons at generating interest in gardening products), or might give advice on the return from particular types of substantive offers (e.g., a 20% discount might generate 40% more business than a 10% discount). Additionally, the portal might advise the business on how to time coupon offers. For example, the portal might advise the business on when to distribute coupons for products in relation to an upcoming event. The advice might be based on the platform provider's historical analysis of coupons that have been distributed though its platforms.

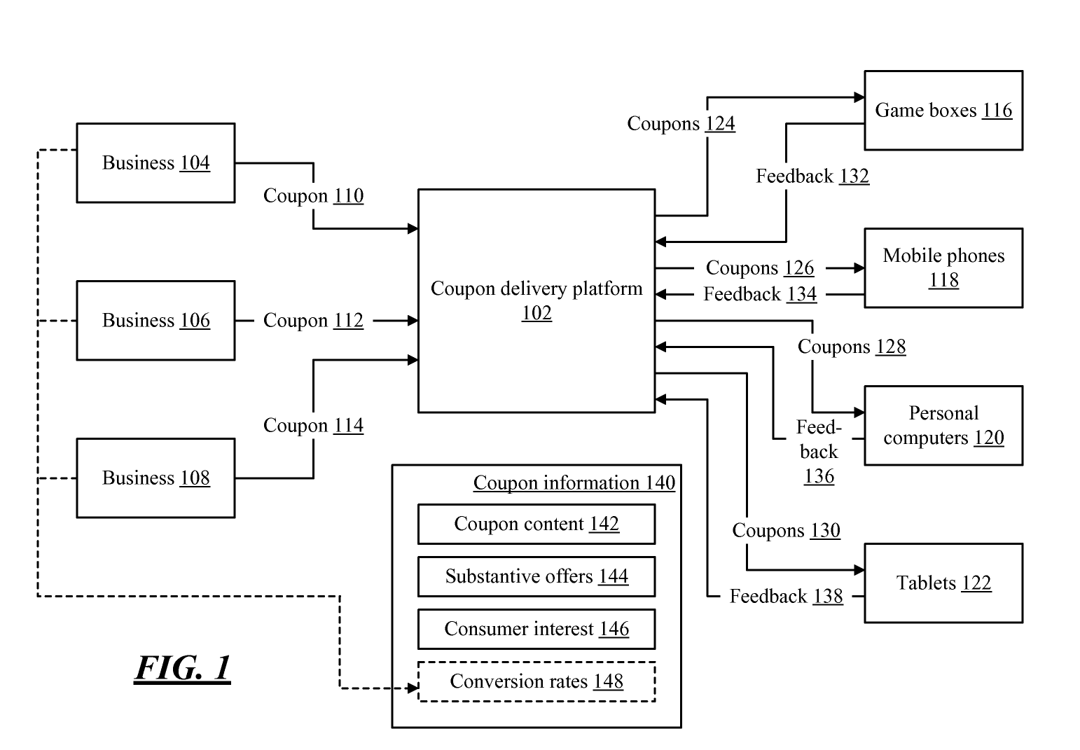

Turning now to the drawings, FIG. 1 shows an example scenario in which coupons are distributed, and in which information on the coupons is collected. Coupon delivery platform 102 is a machine, or arrangement of machines, that delivers coupons to users through various channels. The coupons come from businesses, or other entities, that want to promote their endeavors through the use of coupons. FIG. 1 shows three example businesses 104, 106, and 108, that provide coupons 110, 112, and 114, respectively. For example, business 104 might be a garden center, and coupon 110 might be an offer for $5 off the price of a rake. Business 106 might be a restaurant, and coupon 112 might be an offer for 20% off the bill for a party of four. Any type of coupon could be offered.

Coupon delivery platform 102 delivers the coupons to users through various channels. For example coupon delivery platform 102 might be operated by a company that supports game boxes 116, mobile phones 118, personal computers 120, tablets 122, and other types of systems. Coupon delivery platform 102 may interface with those systems to show coupons to the users of those systems. For example, a game box may have a runtime engine that interfaces with coupon delivery platform 102 to obtain and render coupons as a way of monetizing the games that are played on the game box. Thus, at an appropriate point in time (e.g., during the intermission for a game), software on the game box may receive and display coupons 124 from coupon delivery platform 102. (Coupons 124 may include one or more of coupons 110-114, but could also include other coupons that are not shown in FIG. 1. The coupons that are delivered to a platform may come from any source.) Similarly, mobile phones 118, personal computers 120, and tablets 122 may have ways to receive coupons 126, 128, and 130, respectively, and show those coupons to users. For example, personal computers, phones, and tablets may show coupons to a user through a browser, or through a variety of applications.

When users see coupons on their various devices, they may interact with the coupons. For example, a user might hover on a coupon, or click the coupon, or download and print the coupon, thereby indicating some level of interest in the coupon. The various devices on which coupons are shown to users may record this interaction, and may communicate feedback to coupon delivery platform 102. The feedback represents data on users' interactions with the coupons that have been shown to them. In the example of FIG. 1, game boxes 116, mobile phones 118, personal computers 120, and tablets 122 communicate feedback 132, 134, 136, and 138, respectively, back to coupon deliver platform 102. It is noted that a user's active engagement with a coupon (e.g., clicking, printing, etc.) constitutes an interaction. However, even a user's ignoring of a coupon constitutes a type of interaction that may be communicated in any of the feedback, since the fact that a user was shown a coupon and ignored it is, in itself, a piece of information about the effectiveness of a coupon that may be of interest to coupon delivery platform.

The various pieces of feedback that are collected by coupon delivery platform 102 constitute coupon information 140, which can later be analyzed. Coupon information 140 may include coupon content 142 (e.g., the words and graphics in the coupon), any substantive offers 144 made in the coupon (e.g., 20% off a dinner check for four people, or $5 off a specific item), and any indications of consumer interest 146 in the coupon (e.g., whether users clicked on, hovered over, or printed the coupon). Additionally, coupon information 140 may include information about conversions 148. “Conversions” refer to events in which people engage in sought-after behavior (e.g., buying an item promoted in an advertisement or coupon). A coupon delivery platform can determine when users express interest in a coupon, but it may be harder to glean information about whether a conversion (e.g., an actual product purchase, a “check-in” on a social network site, etc.) occurred after interest in the coupon was expressed. Thus, information about conversions may be received directly from businesses 104-108.

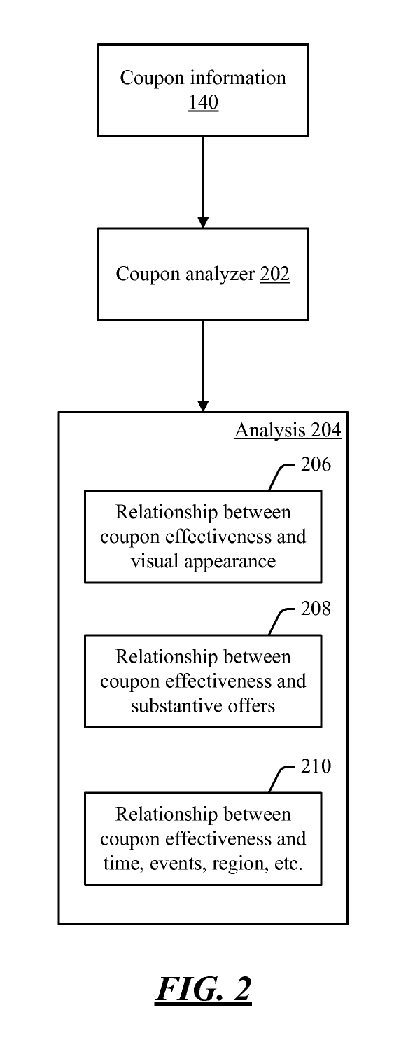

Once coupon information has been collected, it may be analyzed. FIG. 2 shows an example system that analyzes coupon information.

A coupon analyzer 202 receives coupon information 140. Coupon analyzer may comprise hardware and/or software that creates an analysis 204 of coupon information 140. Coupon analyzer 202 may use any appropriate technique to perform the analysis. In one example, coupon analyzer 202 performs a statistical analysis that determines the correlation between features of a coupon and the effectiveness of the coupon. For example, coupon analyzer 202 might examine features of a coupon such as the words used in the coupon, the color of the coupon, the type of graphics used in the coupon, and the substantive nature of the offers made in the coupon. Coupon analyzer 202 may then attempt to determine how these features correlate with measurable aspects of effectiveness such as the number of times a coupon was clicked, downloaded, or printed, how often a conversion occurred, and/or the value of the conversion. Thus, analysis 204 reflects the effectiveness of various types of coupons.

FIG. 2 shows, in the form of a block diagram, some example information that may be included in analysis 204. In one example (at block 206), analysis 204 includes information about the relationship between a coupon's effectiveness and its visual appearance. For example, the analysis may indicate how a coupon's color, type size, graphics, etc., predict the coupon's effectiveness.

In another example (at block 208), analysis 204 includes information about the relationship between a coupon's effectiveness and the substantive offers contained in the coupon. For example, the analysis may indicate how the specific dollar amount of the coupon, or the percentage discount offered in the coupon, relates to the rate at which the coupon is downloaded, or the rate at which conversions occur.

In another example (at block 210), analysis 204 includes information about the relationship between a coupon's effectiveness and the substantive offers and external factors such as the time of year, the type of events that are occurring (or have occurred), the region in which the coupon is offered, etc. For example, coupons for surplus pumpkins might be particularly effective after Halloween. Or coupons for flashlights might be particularly effective when a major storm is being predicted in the next few days. Or a coupon for a particular type of book might be more effective in one region of the country than another. Coupon effectiveness could be affected by many types of external factors. The foregoing are some examples of how external factors relate to coupon effectiveness, but the subject matter herein includes any appropriate example.

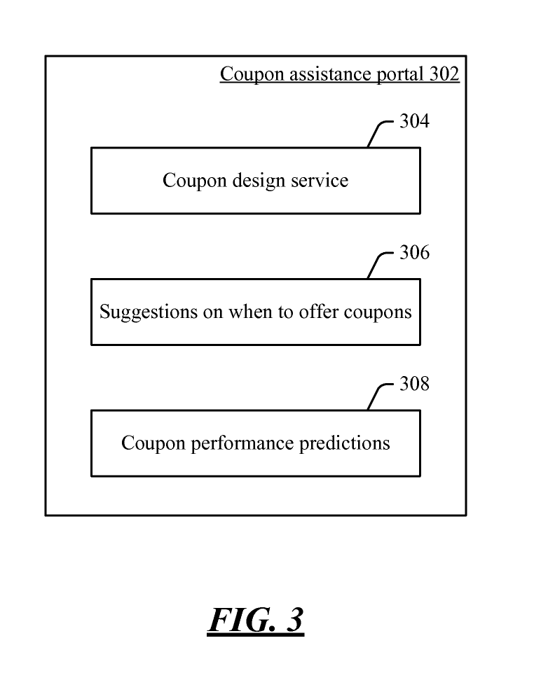

In order to provide advice on coupons to businesses, the operator of a coupon delivery platform may provide a coupon assistance portal to assist businesses in designing coupons. The coupon assistance portal may also assist businesses in designing coupon dissemination strategies. FIG. 3 shows an example of a coupon assistance portal 302.

Coupon assistance portal 302 may be a web site that businesses can access in order to design and disseminate coupons. Coupon assistance portal 302 may provide various features such as a coupon design service (block 304), suggestions on when to offer coupons (block 306), and coupon performance predictions (block 308).

A coupon design service may offer a business suggestions as to the appearance and/or content of its coupons. For example, the coupon design service may suggest particular graphics, colors, typefaces, substantive offers, etc., based on what types of coupons have been successful in the past.

The portal may make suggestions on when to offer coupons. For example, the portal may suggest coupons timed to coincide with particular holidays, when the coupons cover items relating to those holidays. Or the portal may suggest coupons based on changeable conditions such as weather. For example, the portal may suggest coupons for emergency supplies when a large storm is predicted, or may suggest coupons for electric fans in the event of a sudden, unseasonable heat wave.

Additionally, the portal may offer performance predictions. For example, if a business designs a green-colored coupon having particular text that offers 20% off on gardening products, the portal may make predictions as to the likely conversion rate from such a coupon. Or, if the business's goal is to increase check-ins on a social networking site, the portal might provide a prediction as to how many check-ins are likely to result from such a coupon. These predictions may come from the analysis discussion above, since the analysis may reflect the relationship between a coupon's features and the effectiveness of the coupon.

It is noted that the advice given about coupons may combine the various pieces of information given above. For example, as to the design of the coupon, the particular visual and content features of the coupon that are recommended might be dependent on the time at which the coupon is being offered. E.g., orange coupons written in an informal typeface might be more appealing in the summer, while red and green coupons in a formal typeface might be more appealing in the winter. Or, coupons for small discounts might be effective at particular times of the year, while other times of the year might call for larger discounts in order for the coupons to be effective. In general, the advice given by coupon assistance portal can be based on any combination of analyses about coupons. However, it is noted that the advice that is offered may generally be based on analysis of historical data concerning coupons that have been issued in the past.

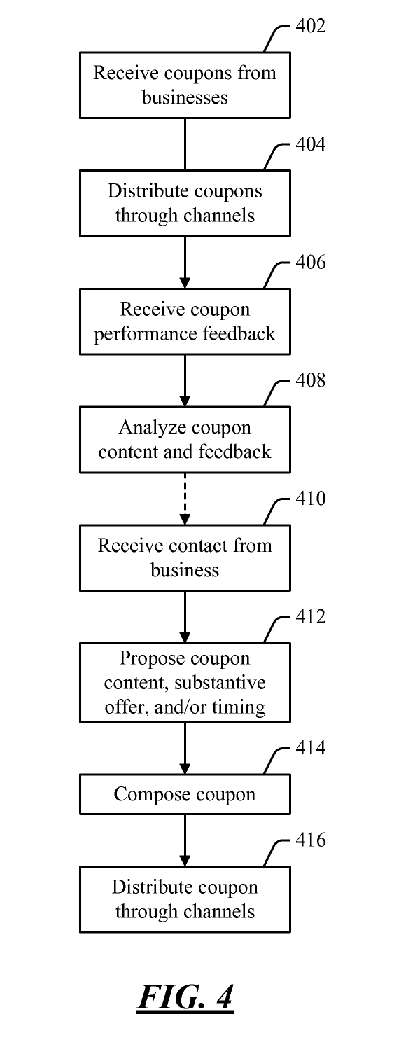

FIG. 4 shows an example process in which coupons are analyzed, and in which the analysis is used to assist in the authoring and dissemination of new coupons.

At 402, coupons are received from businesses. The coupons may be received by a coupon delivery platform, and the coupons that are received are coupons that the business wants to disseminate through channels that are available through the platform. At 404, the coupons are distributed through channels. As described above in connection with FIG. 1, these channels may include personal computers, smart phones, tablets, game boxes, or any other appropriate platform. At 406, feedback on the coupon's performance is received. As discussed above, this feedback may indicate expressions of consumer interest in the coupons, conversion rates for the coupons, or any other information.

At 408, the coupons' content, and any feedback on the coupons, are analyzed. The analysis may indicate the relationship between a coupon's features, external factors (such as the time of year or the weather), and the coupon's performance. It is noted that the example described above in connection with FIG. 1 shows a coupon delivery platform that analyzes the content that the platform delivers. However, the component that performs the analysis could receive the coupons to analyze in any appropriate matter—e.g., from feeds, by crawling web sites, through Application Programming Interfaces (APIs) provided by coupon providers, or by any other mechanism.

At some subsequent point in time (as indicated by the dotted arrow in FIG. 4), a contact from a business is received (at 410). The contact may be received by a coupon assistance portal from a business that is interested in creating and/or disseminating coupons. At 412, the portal may propose the content, substance, and/or timing of coupons. At 414, the business may then compose a coupon (possibly based on the advice that it received from the portal). At 416, the business then may use the coupon delivery platform to give instructions for the distribution of the coupon, in order to have the coupon distributed through appropriate channels.

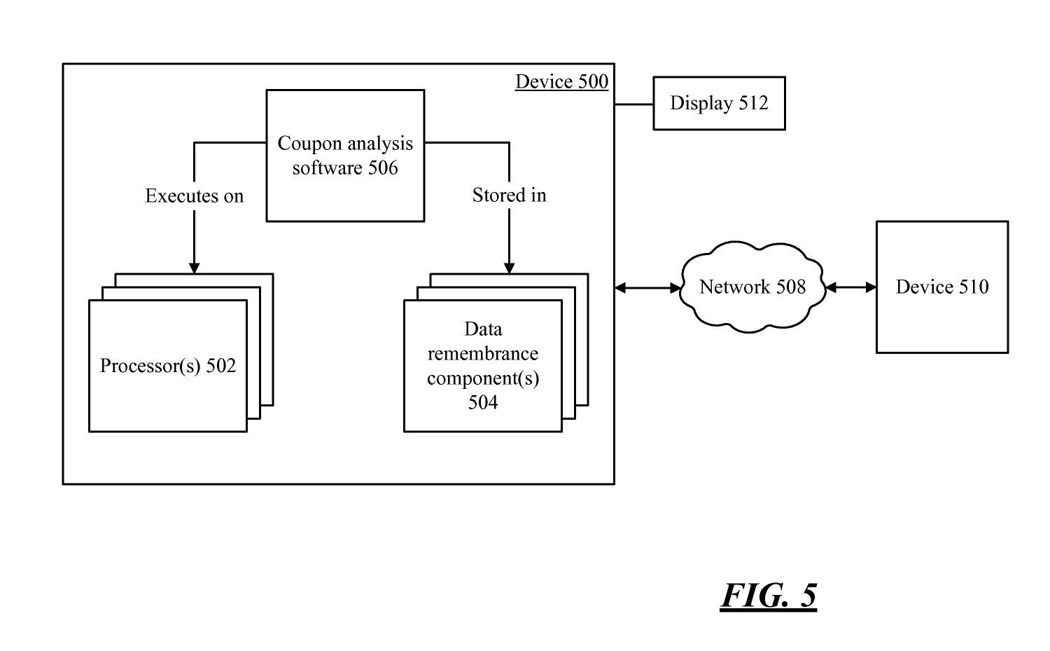

FIG. 5 shows an example environment in which aspects of the subject matter described herein may be deployed.

Device 500 includes one or more processors 502 and one or more data remembrance components 504. Device 500 may be any type of device with some computing power. A smart phone is one example of device 500, although device 500 could be a desktop computer, laptop computer, tablet computer, set top box, or any other appropriate type of device. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 500 may comprise, or be associated with, display 512, which may be a cathode ray tube (CRT) monitor, a liquid crystal display (LCD) monitor, or any other type of monitor. Display 512 may be an output-only type of display; however, in another non-limiting example, display 512 may be (or comprise) a touch screen that is capable of both displaying and receiving information.

Software may be stored in the data remembrance component(s) 504, and may execute on the one or more processor(s) 502. An example of such software is coupon analysis software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more device-readable media. Such instructions, when executed by a phone, a computer, or another machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium.

Computer-readable media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 500 may be communicatively connected to one or more other devices through network 508. device 510, which may be similar in structure to device 500, is an example of a device that can be connected to device 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium that stores executable instructions for distributing coupons, the executable instructions, when executed by a computer, causing the computer to perform acts comprising:
analyzing first content of coupons and feedback on performance of said coupons to determine a first relationship between effectiveness of said coupons and said first content;
proposing, to an entity, second content for a coupon, said second content being based on what content, as determined from said first relationship, is likely to lead to an effective coupon campaign;
receiving, from said entity, a design of said coupon and distribution instructions for said coupon; and
distributing said coupon through electronic media channels based on said instructions.

2. The computer-readable medium of claim 1, said analyzing indicating a first correlation between a graphic and said effectiveness, said second content that is proposed to said entity comprising said graphic.

3. The computer-readable medium of claim 1, said analyzing indicating a correlation between a substantive offer and said effectiveness, said second content that is proposed to said entity comprising said substantive offer.

4. The computer-readable medium of claim 1, said acts further comprising:
analyzing said coupons and external factors to determine a second relationship between a first external factor and said effectiveness; and
proposing a timing of said distribution of said coupon based on said second relationship.

5. The computer-readable medium of claim 4, said external factor comprising a weather event.

6. The computer-readable medium of claim 4, said external factor comprising a time of year.

7. The computer-readable medium of claim 1, said effectiveness being determined based on a number of clicks that said coupons have received, a number of times that said coupons have been downloaded or printed, or a number of conversions that have resulted from said coupons.

8. A method of distributing coupons, the method comprising:
using a processor to perform acts comprising:
receiving a plurality of coupons;
distributing said coupons through a plurality of channels;
receiving feedback on effectiveness of said coupons based on whether said coupons are generating consumer interest;
analyzing first content of said coupons and said feedback to determine a first relationship between said effectiveness and said first content;
receiving a contact from an entity through a portal;
proposing, to said entity through said portal, second content for a coupon, said second content being based on what content, as determined from said first relationship, is likely to lead to an effective coupon campaign;
receiving, from said entity, a design of said coupon and distribution instructions for said coupon; and
distributing said coupon through said channels based on said instructions.

9. The method of claim 8, said analyzing indicating a first correlation between a graphic and said effectiveness, said second content that is proposed to said entity comprising said graphic.

10. The method of claim 8, said analyzing indicating a correlation between a substantive offer and said effectiveness, said second content that is proposed to said entity comprising said substantive offer.

11. The method of claim 8, said acts further comprising:
analyzing said coupons and external factors to determine a second relationship between a first external factor and said effectiveness; and
proposing a timing of said distribution of said coupon based on said second relationship.

12. The method of claim 11, said external factor comprising a weather event or a time of year.

13. The method of claim 8, said effectiveness being determined based on a number of clicks that said coupons have received, a number of times that said coupons have been downloaded or printed, or a number of conversions that have resulted from said coupons.

14. A system for distributing coupons, the system comprising:
a memory;
a processor; and
a component that is stored in said memory, that executes on said processor, that analyzes first content of coupons and feedback on performance of said coupons to determine a first relationship between effectiveness of said coupons and said first content, that proposes, to an entity, second content for a coupon, said second content being based on what content, as determined from said first relationship, is likely to lead to an effective coupon campaign, that receives, from said entity, a design of said coupon and distribution instructions for said coupon, and that distributes said coupon through electronic media channels based on said instructions.

15. The system of claim 14, analysis performed by said component indicating a first correlation between a graphic and said effectiveness, said second content that is proposed to said entity comprising said graphic.

16. The system of claim 14, analysis performed by said component indicating a correlation between a substantive offer and said effectiveness, said second content that is proposed to said entity comprising said substantive offer.

17. The system of claim 14, said component analyzing said coupons and external factors to determine a second relationship between a first external factor and said effectiveness, and said component proposing a timing of said distribution of said coupon based on said second relationship.

18. The system of claim 17, said external factor comprising a weather event.

19. The system of claim 17, said external factor comprising a time of year.

20. The system of claim 14, said effectiveness being determined based on a number of clicks that said coupons have received, a number of times that said coupons have been downloaded or printed, or a number of conversions that have resulted from said coupons.
